(19) United States
(12) Patent Application Publication
(10) Pub. No.: US 2005/0254150 A1
(43) Pub. Date: Nov. 17, 2005

(54) Rear-endicator

(76) Inventor: Danny Lee Bumgarner, Columbus, GA (US)

Correspondence Address: Danny Lee Bumgarner, 4103 Athea Dr., Columbus, GA, 31907, US

(21) Appl. No.: 10/843,648

(22) Filed: May 6, 2004

(51) Int. Cl. G02B 5/08

(52) U.S. Cl. 359/852; 359/838

(57) ABSTRACT

Rear endicator is a new product made of plastic to be placed on the rear of a motor home or trailer so the driver can see exactly where the rear of there vehicle is by looking in there mirror.

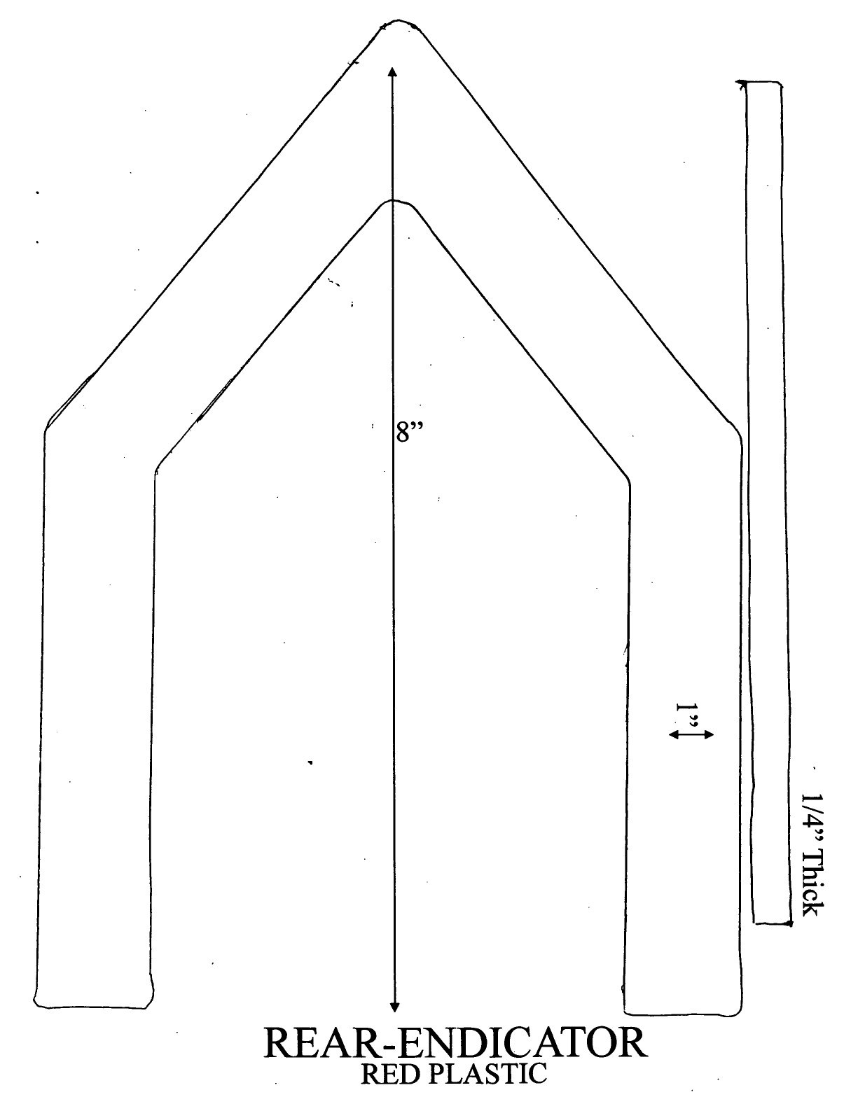

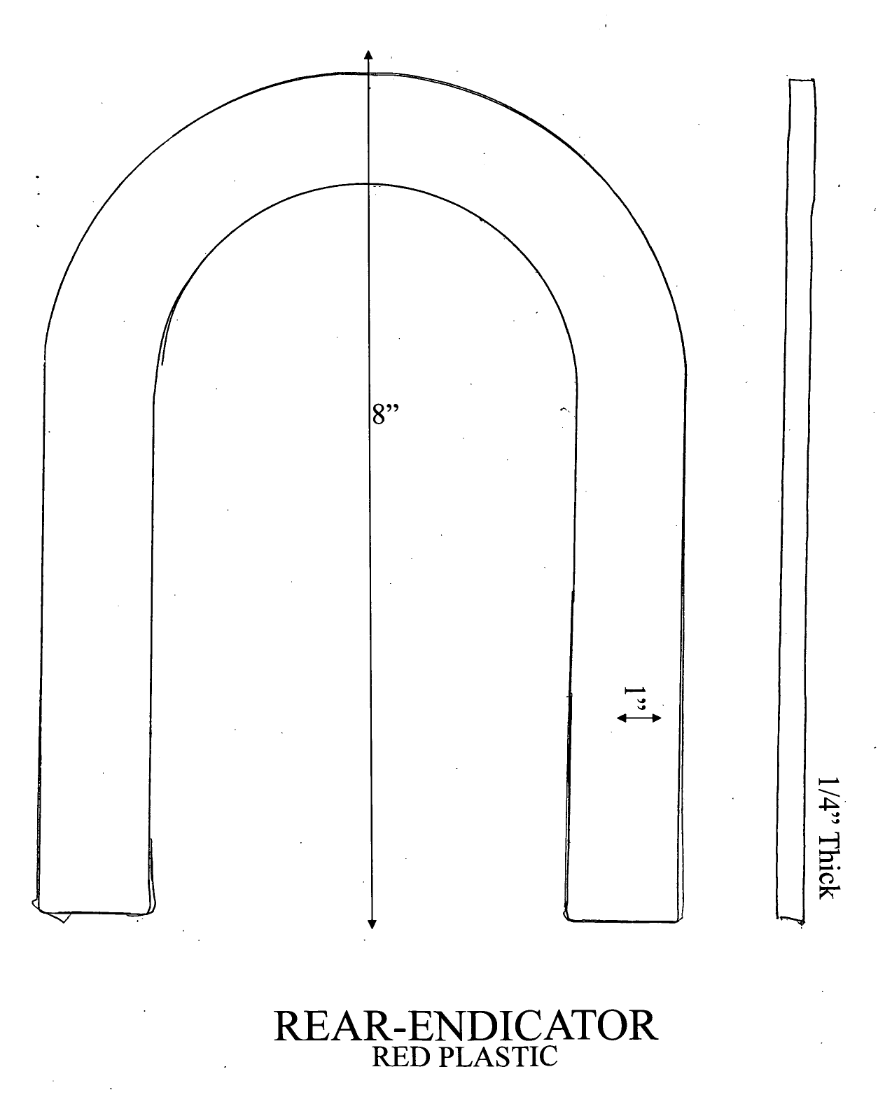

As a Truck Driver I have seen many accidents on the road!

Rear-Endicator I alone invented that is 8″long—1″ wide and ¼ Thick. Made of flexible Red Plastic to be mounted on the rear of a Tractor Trailor—Motor Home—Trailer being towed, so the driver can see by a look in his or her mirror and be able to see exactly where the rear of the vehicle is!

Especially when changing lanes or backing up. I am now applying for a utility patent if more money is needed please let me know!

1. I claim that this rear-endicator will help save lives by giving the driver of a motor home, or pulling a trailer to be able to see by looking into their mirrors where the end of the vehicle is.
